(19) United States
(12) Patent Application Publication
(10) Pub. No.: US 2014/0093115 A1
(43) Pub. Date: Apr. 3, 2014

(54) AMBIENT VENT CANALPHONE SYSTEM AND METHOD

(71) Applicant: Jerry Harvey, Apopka, FL (US)

(72) Inventor: Jerry Harvey, Apopka, FL (US)

(21) Appl. No.: 14/043,981

(22) Filed: Oct. 2, 2013

Related U.S. Application Data
(60) Provisional application No. 61/709,174, filed on Oct. 3, 2012.

(51) Int. Cl. H04R 1/10

(52) U.S. Cl. CPC H04R 1/1058
USPC 381/380; 29/594

(57) ABSTRACT

A canalphone system may include a canalphone housing, and an ambient vent opening in the canalphone housing larger than 0.04 square inches. The system may also include an acoustic damper adjacent the ambient vent opening. The system may further include a liquid diverter carried by the canalphone housing that limits liquid flow into the ambient vent opening.

### CROSS-REFERENCE TO RELATED APPLICATIONS

This application claims the benefit of copending U.S. Provisional Application No. 61/709,174, filed 3 Oct. 2012 (Agent Docket No. JH06(P)). The present application and the application identified above both include identical inventorship and ownership.

### BACKGROUND

The embodiments relate to the field of canalphones.

### DESCRIPTION OF BACKGROUND

There are many different types of personal listening devices such as headphones, earbuds, canalphones, and/or the like. Headphones are personal listening devices that are held in close proximately to the ear by some support system. Earbuds are small personal listening devices that are positioned directly in front of the ear canal and are substantially smaller than a person's outer ear. Similarly, canalphones are personal listening devices that are substantially smaller than a person's outer ear, but they differ from earbuds in that they are placed directly in one end of the ear canal. Both earbuds and canalphones are held in positioned by friction between the ear and the device rather than the support system found in most headphones.

Canalphones are also referred to as in-ear monitors due to how the canalphone is worn by a listener. In other words, a canalphone housing is worn in the ear of the user and not over and/or around the ear of the user. Some canalphones also serve as earplugs due to the way the canalphone limits noise external to the canalphone from entering the ear canal.

### SUMMARY

According to one embodiment, a canalphone system may include a canalphone housing, and an ambient vent opening in the canalphone housing larger than 0.04 square inches. The system may also include an acoustic damper adjacent the ambient vent opening. The system may further include a liquid diverter carried by the canalphone housing that limits liquid flow into the ambient vent opening.

The liquid diverter may also include a canalphone housing exterior face with respect to the canalphone housing's usage position, and a canalphone housing base with respect to the canalphone housing's usage position, the canalphone housing base being below the canalphone housing's exterior face, and the canalphone housing base carrying the ambient vent opening. The liquid diverter may further include a protuberance that shields the ambient vent opening from the liquid flow.

The protuberance may additionally include a channel. The liquid diverter may also include a drip kerf adjacent the ambient vent opening.

The system may further include audio bores within the canalphone housing, and an ambient vent bore within the canalphone housing, the ambient vent bore being shorter than the audio bores. The acoustic damper adjoins the ambient vent bore.

The audio bores may additionally be at least one of tubes separate from the canalphone housing and part of the canalphone housing. The system may also include a high audio driver connected to a first one of the audio bores, a low audio driver connected to a second one of the audio bores, and the low audio driver being acoustically phase correct within at least 60 degrees of the high audio driver.

Another aspect of the embodiments is a method. The method may include sizing an ambient vent opening in a canalphone housing larger than 0.04 square inches. The method may also include positioning an acoustic damper adjacent the ambient vent opening. The method may further include positioning a liquid diverter to limit liquid flow into the ambient vent opening carried by the canalphone housing.

The method may additionally include positioning the ambient vent opening on a canalphone housing base with respect to the canalphone housing's usage position. The method may also include positioning a protuberance on the liquid diverter to shield the ambient vent opening from the liquid flow.

The method may further include providing a channel within the protuberance. The method may additionally include positioning a drip kerf adjacent the ambient vent opening.

The method may also include sizing an ambient vent bore within the canalphone housing where the ambient vent bore is shorter than any audio bore. The method may further include tuning a low audio driver connected to one of the audio bores to be acoustically phase correct within at least 60 degrees of a high audio driver.

In another embodiment, a method may include determining dimensions and placement of an audio bore for a canalphone housing. The method may also include fabricating the audio bore as part of the canalphone housing using the dimensions and the placement. The method may further include making the audio bore and the canalphone housing comprise a monolithic structure.

The method may additionally include providing an ambient vent bore adjacent the audio bore's outlet. The method may also include positioning an acoustic damper adjacent the ambient vent opening.

### BRIEF DESCRIPTION OF THE DRAWINGS

FIG. 1 is a schematic block diagram of a system in accordance with various embodiments.

FIG. 2 is an interior view of an exemplary ambient vent canalphone in accordance with various embodiments.

FIG. 3 is an exterior view of the exemplary ambient vent canalphone of the system in FIG. 1.

FIG. 4 is a flowchart illustrating method aspects according to the embodiments.

FIG. 5 is a flowchart illustrating method aspects according to the method of FIG. 4.

FIG. 6 is a flowchart illustrating method aspects according to the method of FIG. 4.

FIG. 7 is a flowchart illustrating method aspects according to the method of FIG. 6.

FIG. 8 is a flowchart illustrating method aspects according to the method of FIG. 4.

FIG. 9 is a flowchart illustrating method aspects according to the method of FIG. 4.

FIG. 10 is a flowchart illustrating method aspects according to the method of FIG. 4.

FIG. 11 is a flowchart illustrating other method aspects according to the embodiments.

FIG. 12 is a flowchart illustrating method aspects according to the method of FIG. 11.

FIG. 13 is a flowchart illustrating method aspects according to the method of FIG. 11.

FIG. 14 is a flowchart illustrating method aspects according to the method of FIG. 13.

### DETAILED DESCRIPTION

Embodiments will now be described more fully hereinafter with reference to the accompanying drawings, in which preferred embodiments are shown. Like numbers refer to like elements throughout.

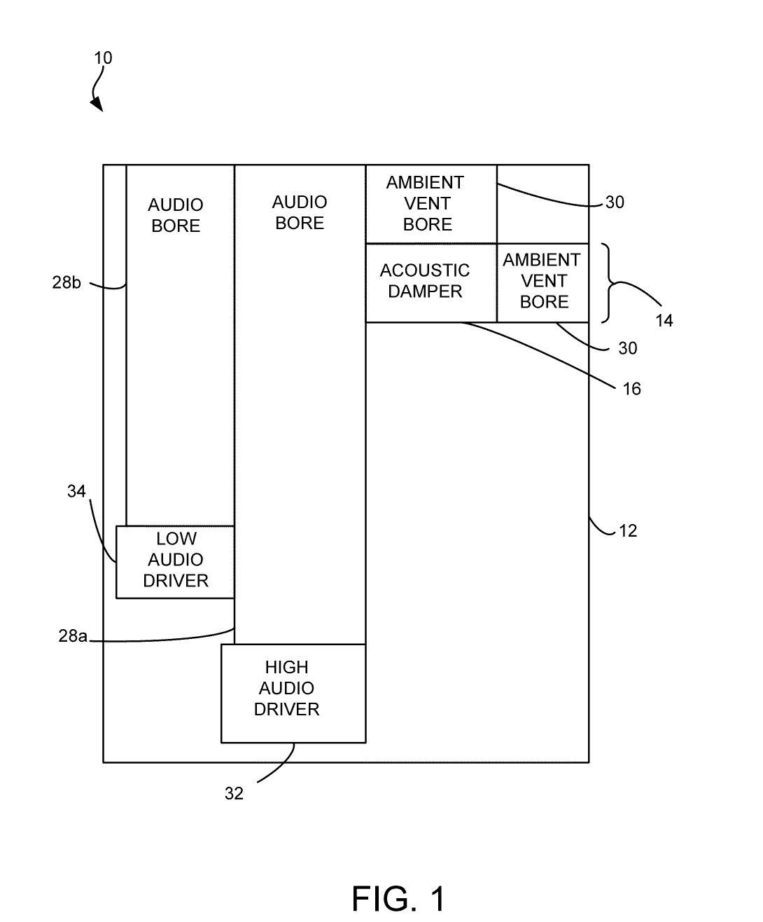

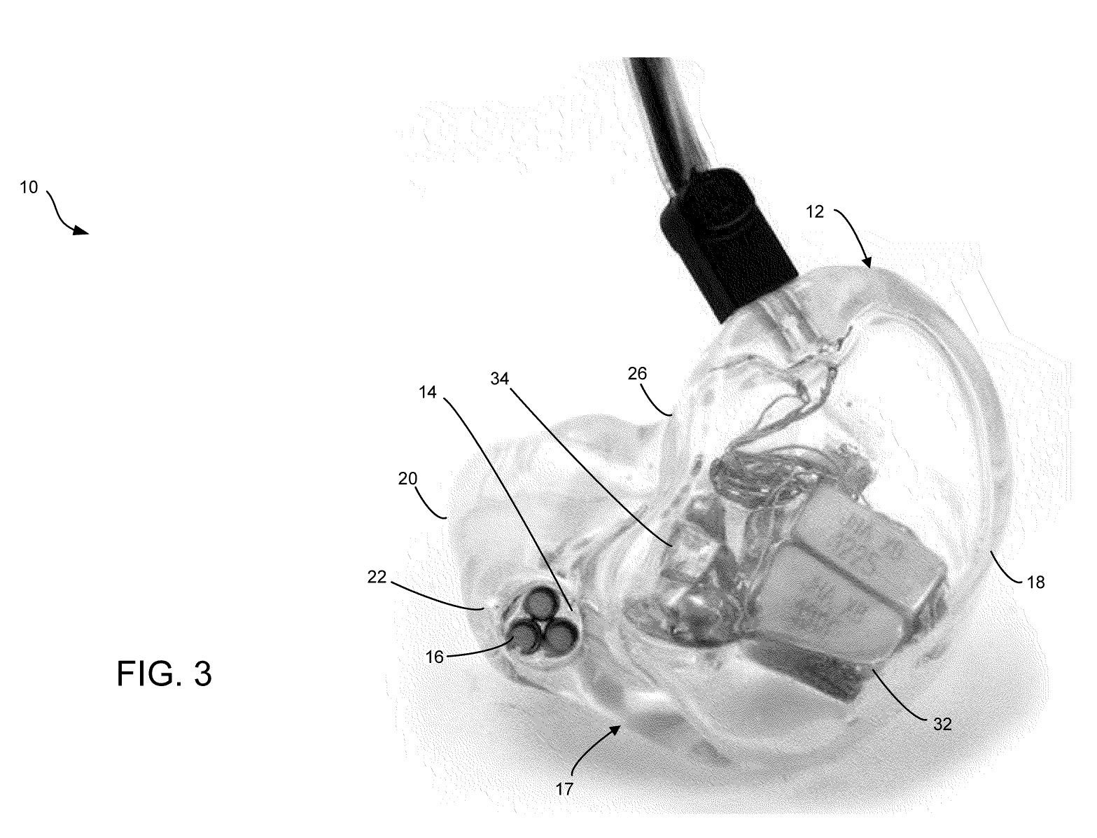

With reference now to FIGS. 1-3, an ambient vent canalphone system 10 is initially described. The system 10 includes a canalphone housing 12 that frictionally engages the ear of a user (not shown) in its usage position.

In one embodiment, the system 10 includes an ambient vent opening 14 in the canalphone housing 12 larger than 0.04 square inches, but smaller than 1 square inch. In another embodiment, the ambient vent opening 14 in the canalphone housing 12 is about 0.11 square inches.

The system 10 also includes an acoustic damper 16 that is adjacent the ambient vent opening 14. The ambient vent opening 14 permits sound external to the system 10 to be heard by the user. The system 10 further includes a liquid diverter 17 carried by the canalphone housing 12 that limits liquid flow (not shown) into the ambient vent opening 14. The liquid can be water, sweat, and/or the like. Such liquids can create performance problems for the acoustic damper 16, for example.

In one embodiment, the liquid diverter 17 may include a canalphone housing exterior face 18 with respect to the canalphone housing's 12 usage position. In another embodiment, the canalphone housing exterior face 18 carries the ambient vent opening 14.

In one embodiment, the liquid diverter 17 may also include a canalphone housing base 20 with respect to the canalphone housing's 12 usage position, and the canalphone housing base is below the canalphone housing's exterior face 18. In another embodiment, the canalphone housing base carries the ambient vent opening 14.

In one embodiment, the canalphone housing exterior face 18 and canalphone housing base 20 placement and layout are selected to limit liquid flow into the ambient vent opening 14. For instance, the canalphone housing exterior face 18 is perpendicular to, or points away from, the intersection with the canalphone housing base 20. In another embodiment, the canalphone housing exterior face 18 points towards the intersection with the canalphone housing base 20. In another embodiment, the canalphone housing exterior face 18 overhangs the canalphone housing base 20.

In one embodiment, the liquid diverter 17 includes a protuberance 22 that shields the ambient vent opening 14 from the liquid flow. In another embodiment, the protuberance 22 comprises a channel 24. For example, the protuberance 22 may have a conical shape with the channel 24 being a passage from the top of the protuberance that extends into the protuberance. In other embodiments, the protuberance 22 has cylindrical, rectangular, irregular, U-shaped, and/or any other shape.

In one embodiment, the liquid diverter 17 includes a drip kerf 26 adjacent the ambient vent opening 14. The drip kerf 26 comprises a relief cut that breaks surface tension in the liquid and deflects liquid flow away from the ambient vent opening 14.

In one embodiment, the system 10 includes audio bores 28a and 28b within the canalphone housing 12, and an ambient vent bore 30 within the canalphone housing. In another embodiment, the ambient vent bore 30 is shorter than the audio bores 28a and 28b.

In one embodiment, the acoustic damper 16 adjoins the ambient vent bore 14. In FIG. 1 the acoustic damper 16 is positioned near the middle of the ambient vent bore 30.

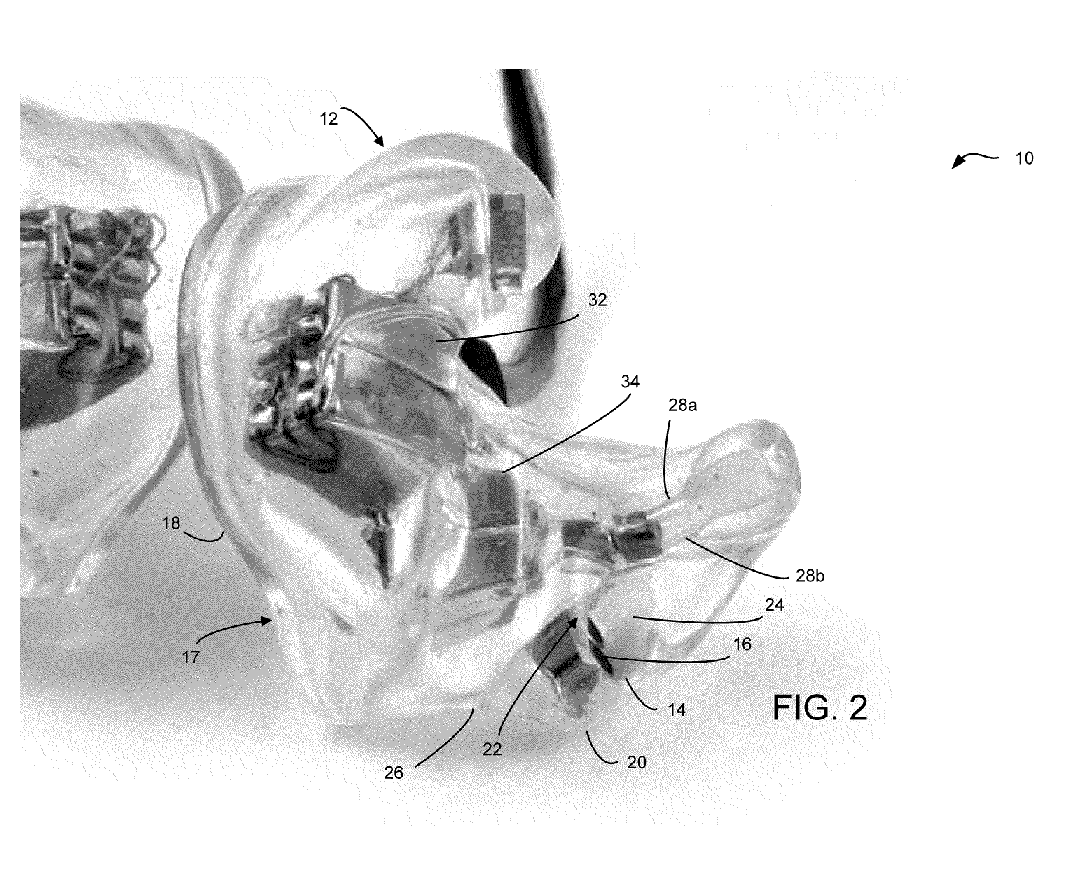

In one embodiment, the audio bores 28a and 28b are tubes separate from the canalphone housing 12 as illustrated in FIG. 2. In other words, the audio bores 28a and 28b are tubes installed into the canalphone housing to create the audio bores. In another embodiment, the audio bores 28a and 28b are created from the canalphone housing itself as illustrated in FIG. 1. Stated another way, a portion of the canalphone housing 12 and the audio bores 28a and 28b are a single monolithic component.

In one embodiment, the system 10 includes a high audio driver 32 connected to a first one of the audio bores 28a, and a low audio driver 34 connected to a second one of the audio bores 28b. In another embodiment, the low audio driver 34 is acoustically phase correct within at least 60 degrees of the high audio driver 32.

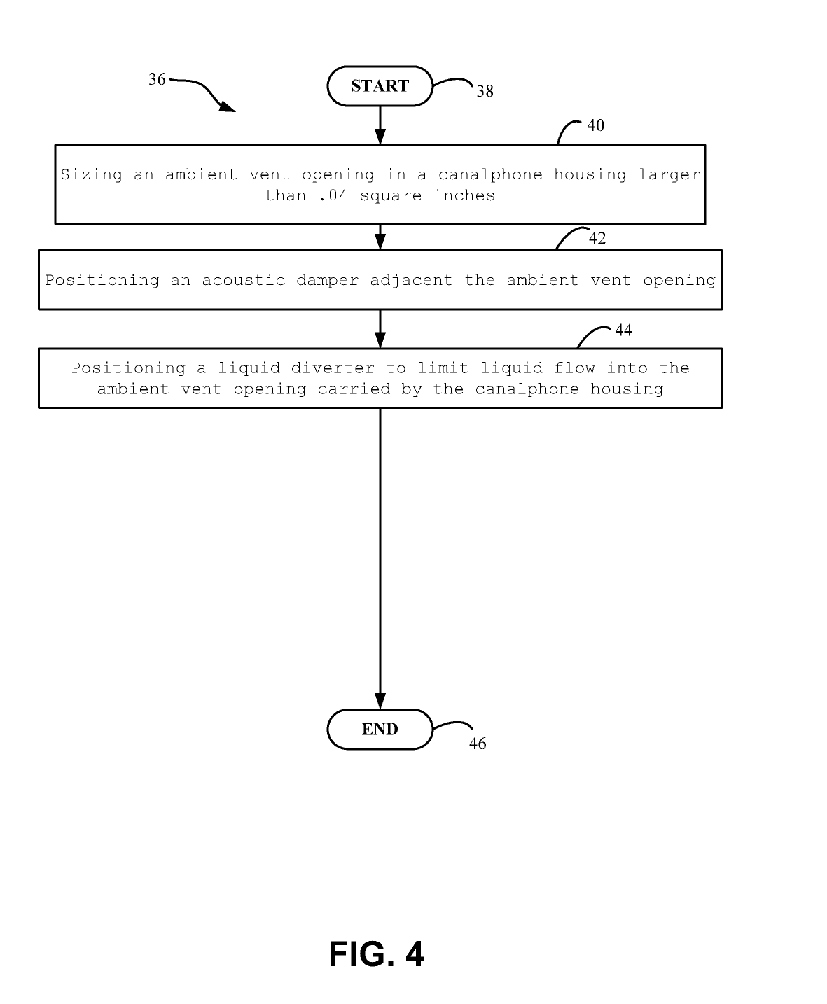

Another aspect of the embodiments is a method, which is now described with reference to flowchart 36 of FIG. 4. The method begins at Block 38 and may include sizing an ambient vent opening in a canalphone housing larger than 0.04 square inches at Block 40. The method may also include positioning an acoustic damper adjacent the ambient vent opening at Block 42. The method may further include positioning a liquid diverter to limit liquid flow into the ambient vent opening carried by the canalphone housing at Block 44. The method ends at Block 46.

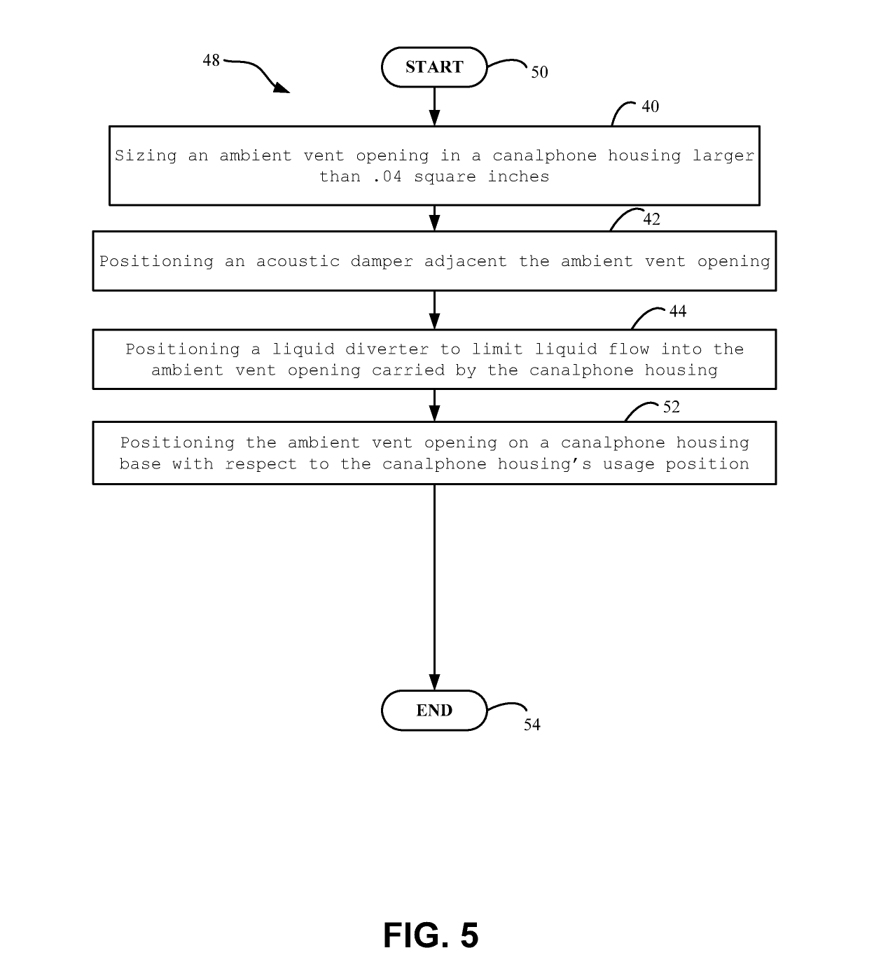

In another method embodiment, which is now described with reference to flowchart 48 of FIG. 5, the method begins at Block 50. The method may include the steps of FIG. 4 at Blocks 40, 42, and 44. The method may further include positioning the ambient vent opening on a canalphone housing base with respect to the canalphone housing's usage position at Block 52. The method ends at Block 54.

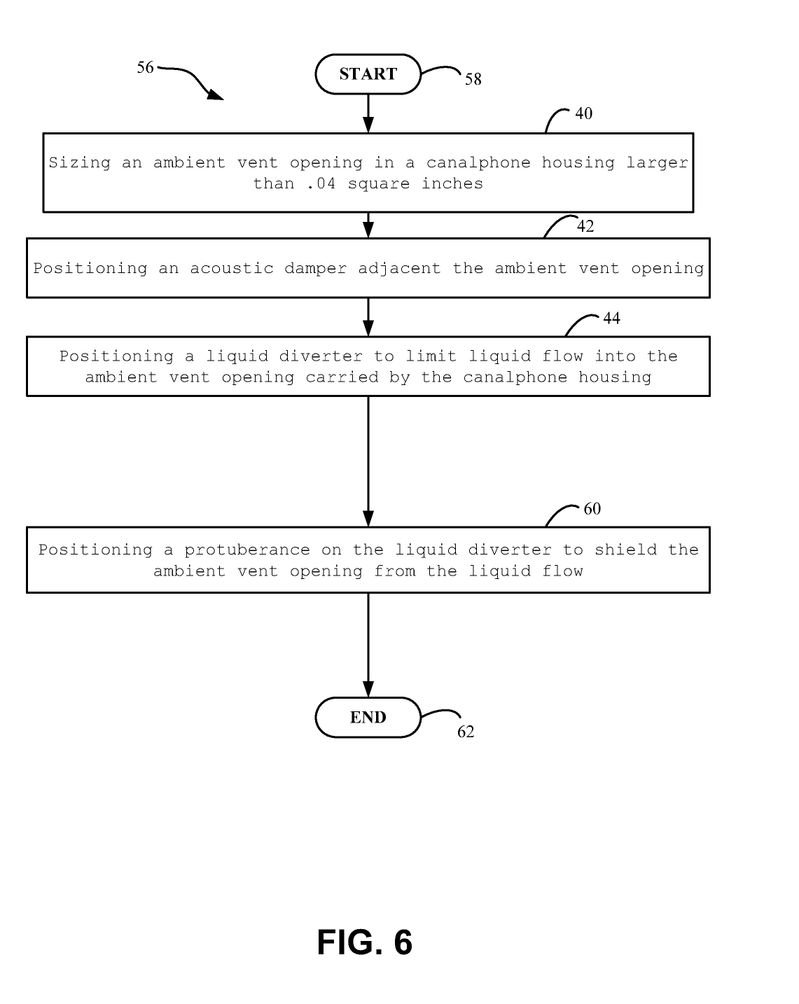

In another method embodiment, which is now described with reference to flowchart 56 of FIG. 6, the method begins at Block 58. The method may include the steps of FIG. 4 at Blocks 40, 42, and 44. The method may further include positioning a protuberance on the liquid diverter to shield the ambient vent opening from the liquid flow at Block 60. The method ends at Block 62.

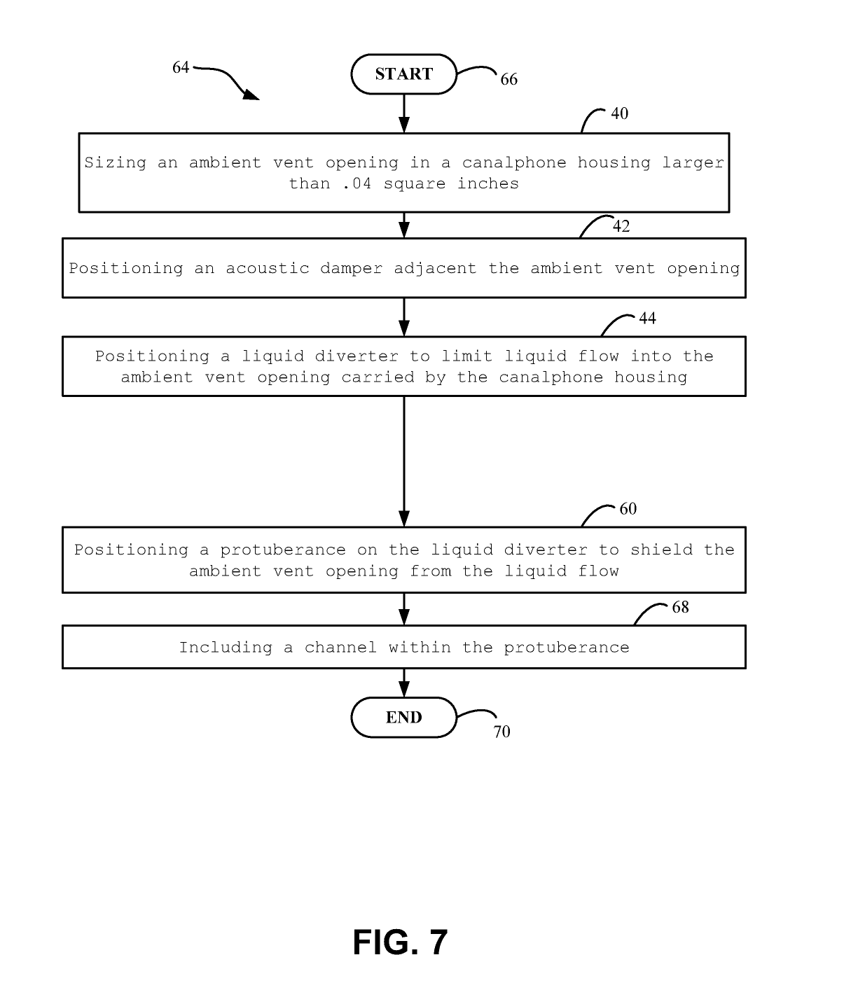

In another method embodiment, which is now described with reference to flowchart 64 of FIG. 7, the method begins at Block 66. The method may include the steps of FIG. 6 at Blocks 40, 42, 44, and 60. The method may further include providing a channel within the protuberance at Block 68. The method ends at Block 70.

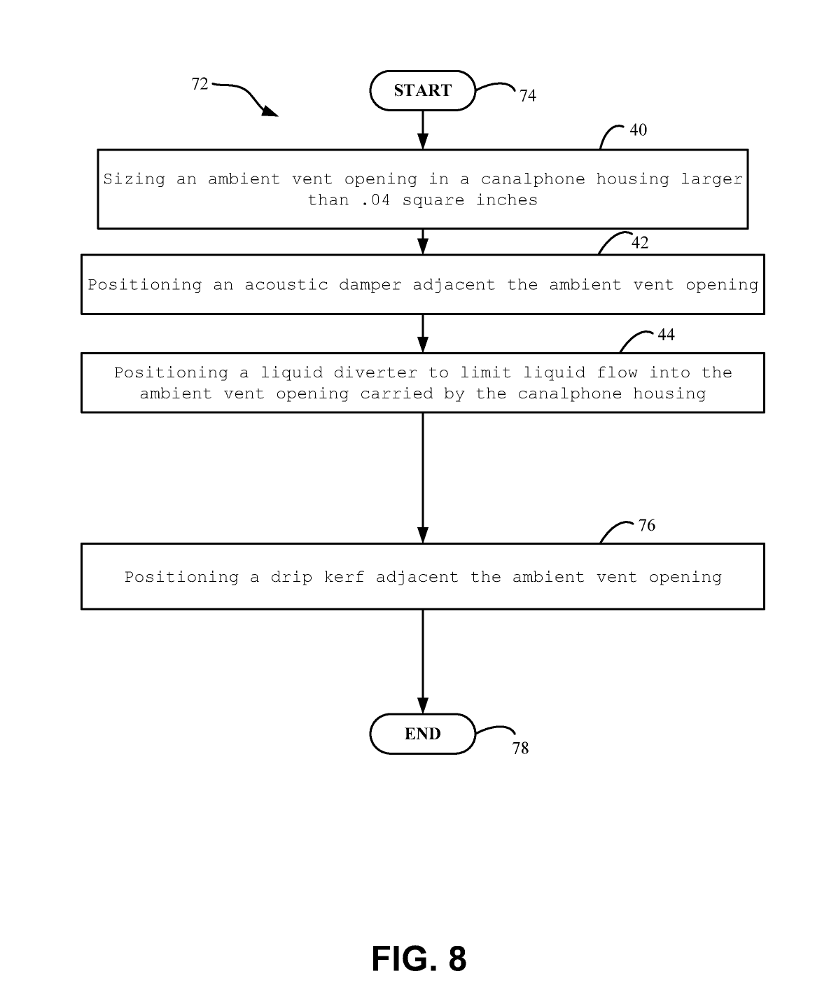

In another method embodiment, which is now described with reference to flowchart 72 of FIG. 8, the method begins at Block 74. The method may include the steps of FIG. 4 at Blocks 40, 42, and 44. The method may further include positioning a drip kerf adjacent the ambient vent opening at Block 76. The method ends at Block 78.

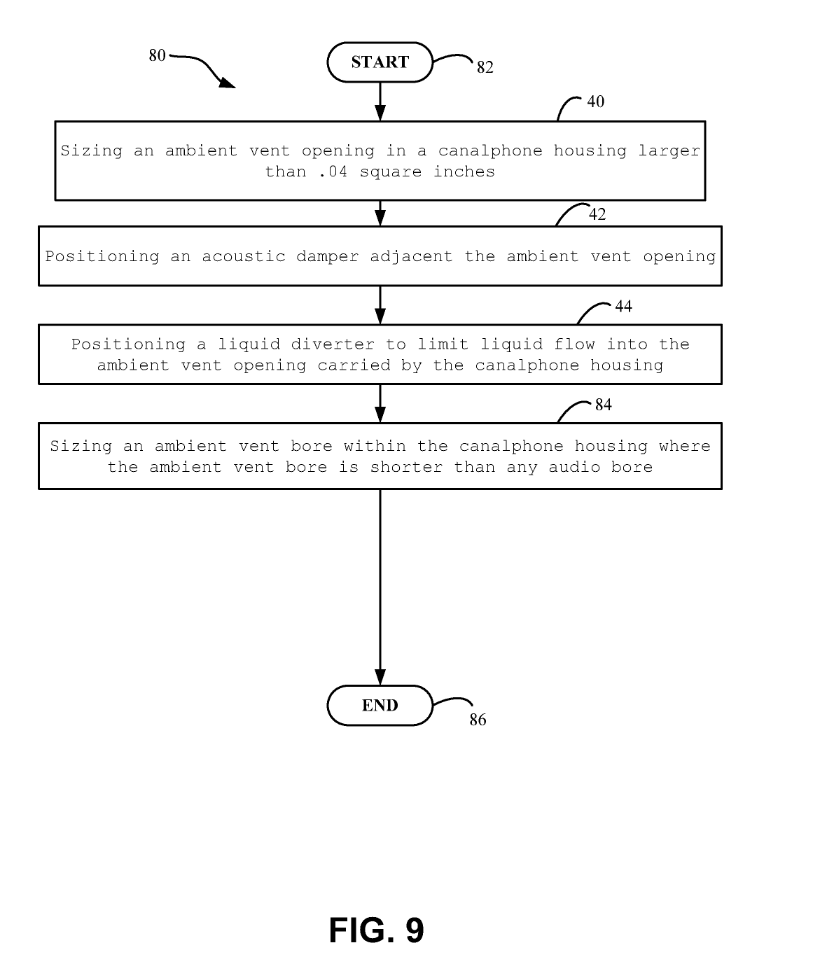

In another method embodiment, which is now described with reference to flowchart 80 of FIG. 9, the method begins at Block 82. The method may include the steps of FIG. 4 at Blocks 40, 42, and 44. The method may further include sizing an ambient vent bore within the canalphone housing where the ambient vent bore is shorter than any audio bore at Block 84. The method ends at Block 86.

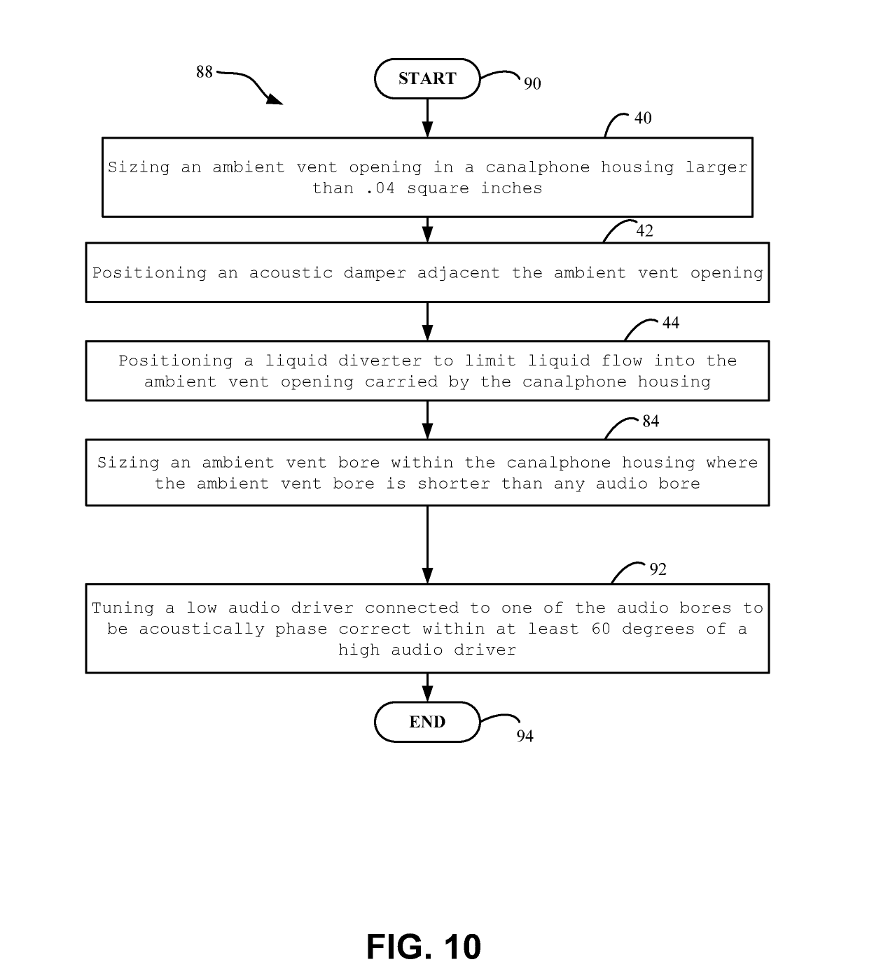

In another method embodiment, which is now described with reference to flowchart 88 of FIG. 10, the method begins at Block 90. The method may include the steps of FIG. 9 at Blocks 40, 42, 44, and 84. The method may further include tuning a low audio driver connected to one of the audio bores to be acoustically phase correct within at least 60 degrees of a high audio driver at Block 92. The method ends at Block 94.

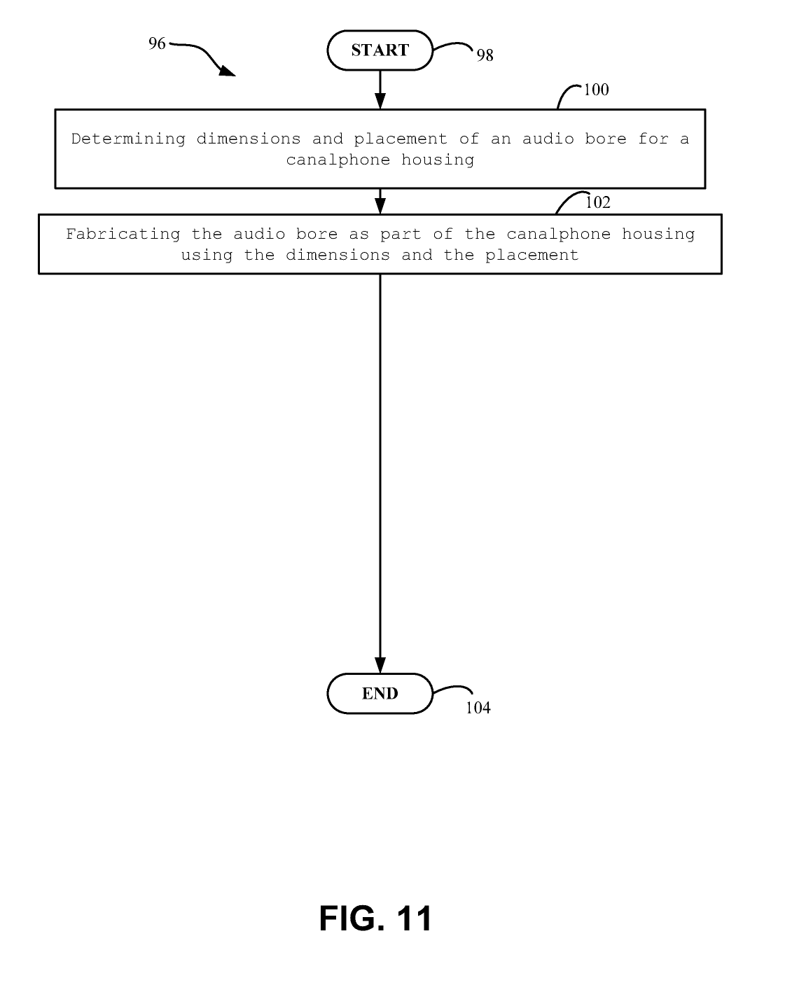

Another aspect of the embodiments is an alternative method, which is now described with reference to flowchart 96 of FIG. 11. The method begins at Block 98 and may include determining dimensions and placement of an audio bore for a canalphone housing at Block 100. The method may also include fabricating the audio bore as part of the canalphone housing using the dimensions and the placement at Block 102. The method ends at Block 104.

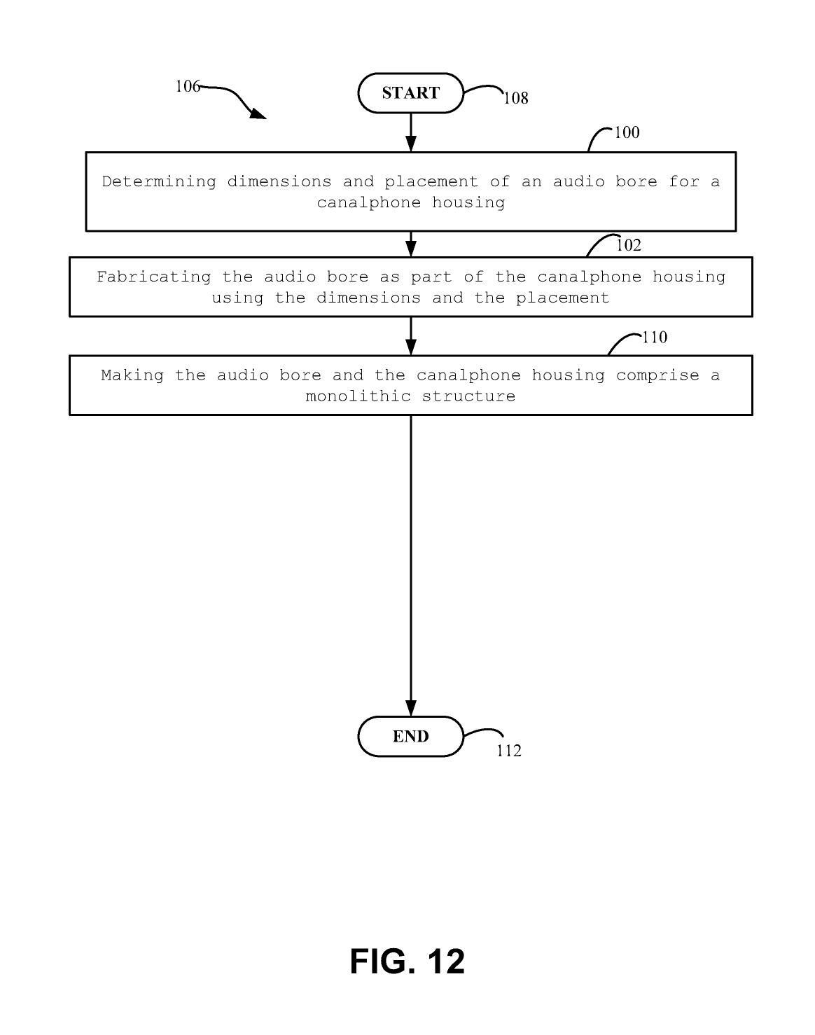

In another method embodiment, which is now described with reference to flowchart 106 of FIG. 12, the method begins at Block 108. The method may include the steps of FIG. 11 at Blocks 100 and 102. The method may further include making the audio bore and the canalphone housing comprise a monolithic structure at Block 110. The method ends at Block 112.

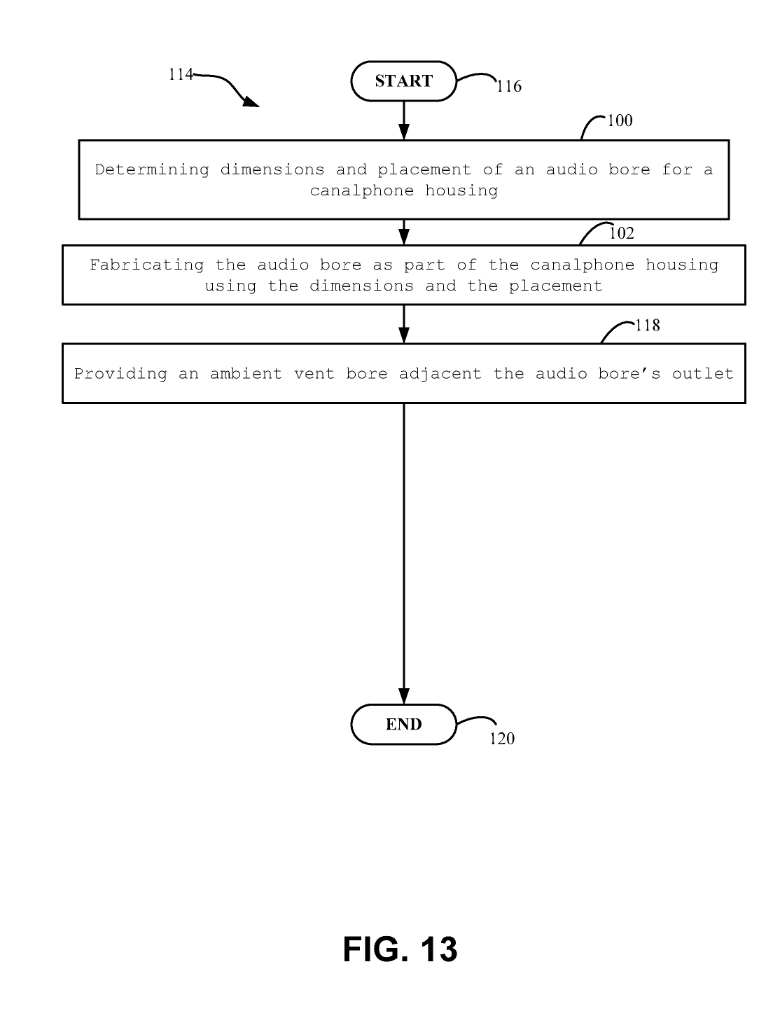

In another method embodiment, which is now described with reference to flowchart 114 of FIG. 13, the method begins at Block 116. The method may include the steps of FIG. 11 at Blocks 100 and 102. The method may further include providing an ambient vent bore adjacent the audio bore's outlet at Block 118. The method ends at Block 120.

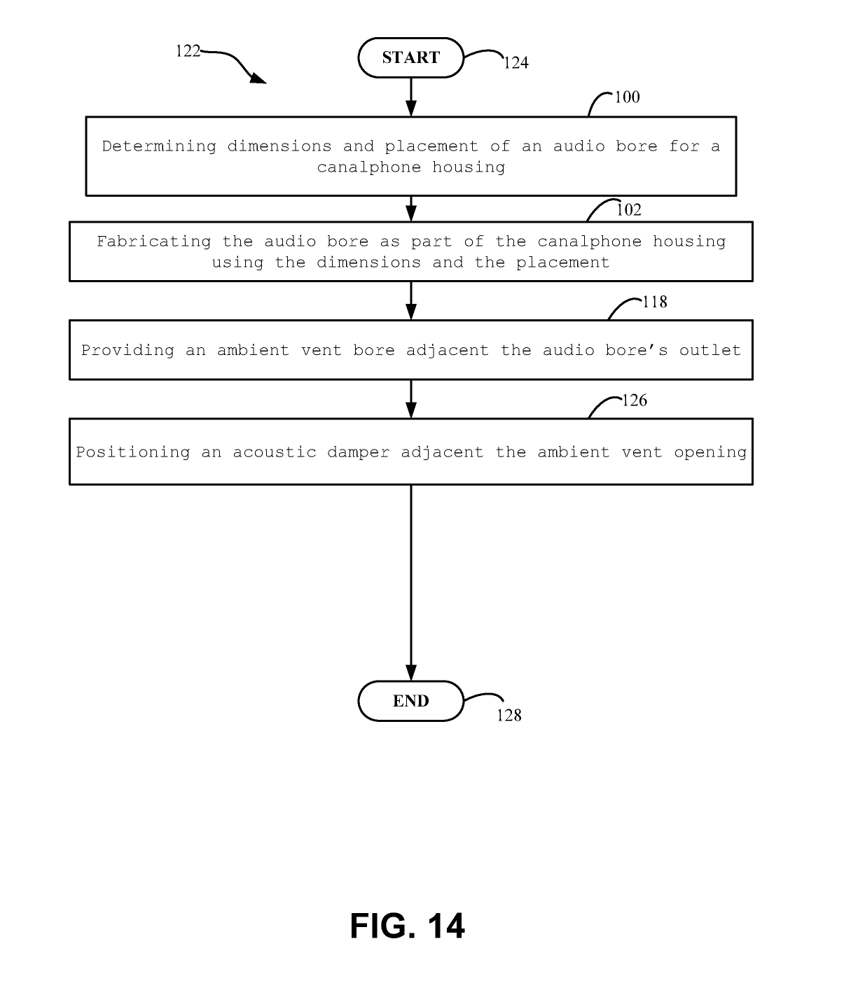

In another method embodiment, which is now described with reference to flowchart 122 of FIG. 14, the method begins at Block 124. The method may include the steps of FIG. 13 at Blocks 100, 102, and 118. The method may further include positioning an acoustic damper adjacent the ambient vent opening at Block 126. The method ends at Block 128.

Since a canalphone housing 12 is very small, it is very difficult to achieve any of the preceding embodiments. However, system 10 overcomes the technical hurdles of providing more components in less space, providing superior sound reproduction, and provides a user a phase corrected canalphone system.

As will be appreciated by one skilled in the art, aspects may be embodied as a system and/or method. The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

What is claimed is:

1. A system comprising:
a canalphone housing;
an ambient vent opening in the canalphone housing larger than 0.04 square inches;
an acoustic damper adjacent the ambient vent opening; and
a liquid diverter carried by the canalphone housing that limits liquid flow into the ambient vent opening.

2. The system of claim 1 wherein the liquid diverter includes:
a canalphone housing exterior face with respect to the canalphone housing's usage position; and
a canalphone housing base with respect to the canalphone housing's usage position, the canalphone housing base being below the canalphone housing's exterior face, and the canalphone housing base carrying the ambient vent opening.

3. The system of claim 1 wherein the liquid diverter includes a protuberance that shields the ambient vent opening from the liquid flow.

4. The system of claim 3 wherein the protuberance comprises a channel.

5. The system of claim 1 wherein the liquid diverter includes a drip kerf adjacent the ambient vent opening.

6. The system of claim 1 further comprising:
audio bores within the canalphone housing; and
an ambient vent bore within the canalphone housing, the ambient vent bore being shorter than the audio bores.

7. The system of claim 6 wherein the acoustic damper adjoins the ambient vent bore.

8. The system of claim 6 wherein the audio bores are at least one of tubes separate from the canalphone housing and part of the canalphone housing.

9. The system of claim 6 further comprising:
a high audio driver connected to a first one of the audio bores;
a low audio driver connected to a second one of the audio bores, and the low audio driver being acoustically phase correct within at least 60 degrees of the high audio driver.

10. A method comprising:
sizing an ambient vent opening in a canalphone housing larger than 0.04 square inches;
positioning an acoustic damper adjacent the ambient vent opening; and
positioning a liquid diverter to limit liquid flow into the ambient vent opening carried by the canalphone housing.

11. The method of claim 10 further comprising positioning the ambient vent opening on a canalphone housing base with respect to the canalphone housing's usage position.

12. The method of claim 10 further comprising positioning a protuberance on the liquid diverter to shield the ambient vent opening from the liquid flow.

13. The method of claim 12 further comprising including a channel within the protuberance.

14. The method of claim 10 further comprising positioning a drip kerf adjacent the ambient vent opening.

15. The method of claim 10 further comprising sizing an ambient vent bore within the canalphone housing where the ambient vent bore is shorter than any audio bore.

16. The method of claim 15 further comprising tuning a low audio driver connected to one of the audio bores to be acoustically phase correct within at least 60 degrees of a high audio driver.

17. A method comprising:
determining dimensions and placement of an audio bore for a canalphone housing; and
fabricating the audio bore as part of the canalphone housing using the dimensions and the placement.

18. The method of claim 17 further comprising making the audio bore and the canalphone housing comprise a monolithic structure.

19. The method of claim 17 further comprising providing an ambient vent bore adjacent the audio bore's outlet.

20. The method of claim 19 further comprising positioning an acoustic damper adjacent the ambient vent opening.
